(19) United States
(12) Patent Application Publication
(10) Pub. No.: US 2025/0198564 A1
(43) Pub. Date: Jun. 19, 2025

(54) Mounting Device for Suspending an Object

(71) Applicant: Murray Thomson, Beaumont (CA)

(72) Inventor: Murray Thomson, Beaumont (CA)

(21) Appl. No.: 19/063,378

(22) Filed: Feb. 26, 2025

Related U.S. Application Data
(63) Continuation-in-part of application No. 18/362,184, filed on Jul. 31, 2023, now Pat. No. 12,259,115.

(51) Int. Cl. F16M 13/02

(52) U.S. Cl. CPC F16M 13/022

(57) ABSTRACT

A mounting device for suspending an object from a gutter. The mounting device includes a fastening member having a first end that secures to gutter. The first end includes a planar segment that is able to rest atop a gutter hanger. A J-shaped channel is disposed on a second end and hangs over an edge of the gutter. An object fastener extends from the second end and forms a channel for receiving and suspending an object therefrom. In this way, the mounting device prevents having to install the object directly to the gutter or house and allows a homeowner to hang objects all year round.

### CROSS REFERENCE TO RELATED APPLICATION

This application claims the benefit of pending U.S. Nonprovisional application Ser. No. 18/362,184 filed on Jul. 31, 2023. The above identified patent application is herein incorporated by reference in its entirety.

### BACKGROUND OF THE INVENTION

The present invention relates to a devices for hanging objects from a house or other building structure. More specifically, the present invention provides a device for securing to a gutter while forming a channel for receiving and suspending an object therefrom.

In outdoor environments, individuals and business owners often seek to enhance the aesthetics of their properties or provide functional benefits by hanging various objects from the exterior walls of their houses or business. Objects such as string lights, birdfeeders, planters, wind chimes, advertisements and outdoor decorations are commonly used for these purposes. To hang items, some people rely on fastening the object directly to the exterior wall or gutter using nails, screws, hooks, or adhesive tapes. Unfortunately, these methods can lead to significant issues for the property owner or caretaker.

One of the main problems with using conventional hanging methods is their impact on the structural integrity and safety of the building structure. Nails, screws, or hooks can create unnecessary punctures or holes in the exterior walls, leading to potential water leakages, rotting, or damage to the building's structure. Additionally, the constant weight and movement of objects, such as heavy planters or birdfeeders, hanging directly from gutters can weaken the gutter system and cause it to detach, posing hazards to pedestrians or property below.

Furthermore, conventional hanging methods often lack versatility and aesthetic appeal. Nails, screws, or hooks are not easy to remove or relocate, leaving behind unsightly holes or marks on the exterior walls or gutters. Furthermore, such methods limit the flexibility to adjust the position of the hung objects as per changing requirements or design preferences, restricting homeowners' ability to optimize their outdoor spaces.

Installing objects directly on the exterior walls or gutters requires tools, precise measurements, and, in some cases, the need for professional assistance, which is time-consuming. Additionally, some residential areas and homeowner associations impose restrictions on the use of conventional hanging methods due to concerns related to property damage, safety hazards, or aesthetic standards. Violation of such guidelines can result in fines or other legal consequences for the homeowners. Some devices exist that temporarily secure to a gutter, but these devices are designed only to receive a string of lights and do not overlay or conceal a gutter hanger. Therefore, there exists a need in the art for a device for securing to a gutter while forming a channel for receiving and suspending an object therefrom.

In light of the devices disclosed in the known art, it is submitted that the present invention substantially diverges in design elements and methods from the known art and consequently it is clear that there is a need in the art for an improvement for a mounting device for suspending an object. In this regard the instant invention substantially fulfills these needs.

### SUMMARY OF THE INVENTION

In view of the foregoing disadvantages inherent in the known types of mounting devices for suspending an object now present in the known art. The present invention provides a new mounting device wherein the same can be utilized for securing to a gutter while forming a channel for receiving and suspending an object therefrom.

It is an objective of the present invention to provide a mounting device comprising a fastening member having a first end and an opposing second end, wherein the first end is adapted to secure to a gutter. In some embodiments, the first end comprises a planar segment configured to rest atop the gutter hanger.

It is another objective of the present invention to provide a mounting device wherein the second end comprises a J-shaped channel configured to hang over an edge of a gutter and an object fastener that extends from an exterior side of the second end, forming a channel for receiving and suspending an object therefrom.

It is another objective of the present invention to provide a mounting device comprising a counterweight disposed on the fastening member configured to allow heavy objects to be suspended from the object fastener.

It is yet another objective of the present invention to provide a mounting system comprising a plurality of mounting devices configured to be spaced equidistant along an exterior of a building to receive an evenly distributed section of string of lights.

It is therefore an object of the present invention to provide a new and improved mounting device for suspending an object, that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the mounting device.

FIG. 2 shows a side view of the first end of the mounting device.

FIG. 3 shows a side perspective view of a plurality of the mounting devices of an embodiment of the mounting system.

### DETAILED DESCRIPTION OF THE INVENTION

Reference is made herein to the attached drawings. Like reference numerals are used throughout the drawings to depict like or similar elements of the mounting device. For the purposes of presenting a brief and clear description of the present invention, the embodiment discussed will be used for suspending objects therefrom. The figures are intended for representative purposes only and should not be considered to be limiting in any respect. Furthermore, the described features, structures, or characteristics may be combined in any suitable manner in one or more embodiments. In the following description, numerous specific details are provided to give a thorough understanding of embodiments.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

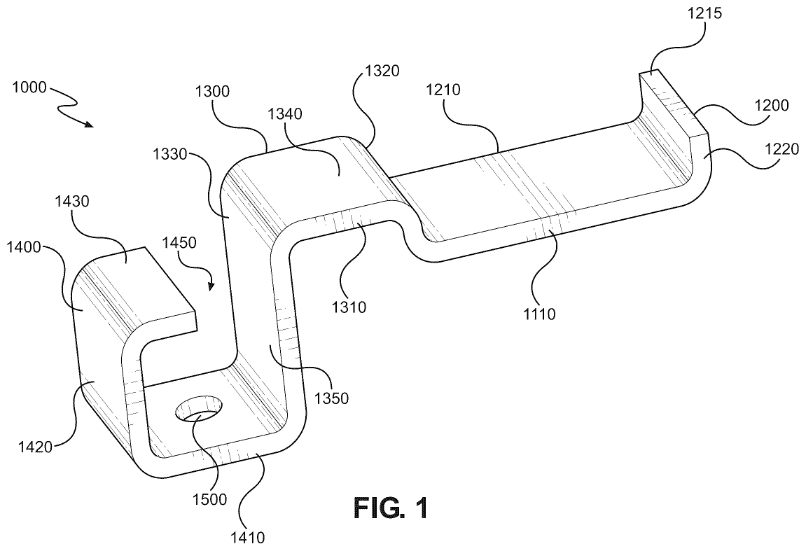

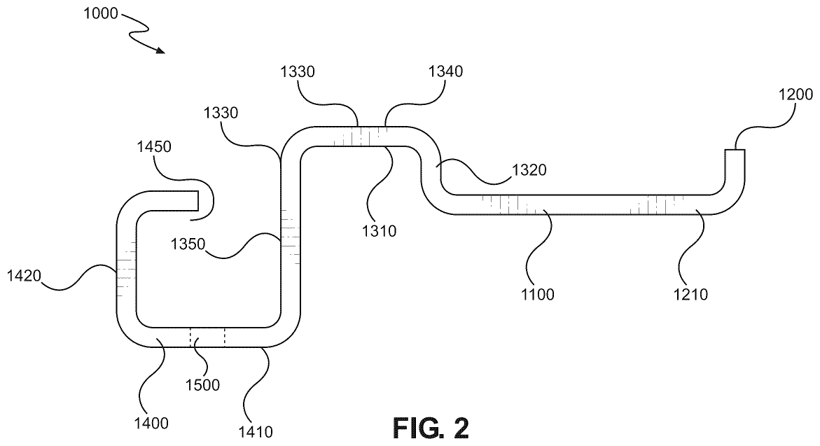

Referring now to FIGS. 1 and 2, there is shown a perspective view and a side view of an embodiment of the mounting device, respectively. In the illustrated embodiment, the mounting device 1000 comprises a fastening member 1100 having a first end 1200 and an opposing second end 1300. The first end 1200 is configured to secure to an existing gutter. In the illustrated embodiment, the first end 1200 of the fastening member 1100 comprises a planar segment 1210 configured to rest atop a gutter hanger. The planar segment 1210 comprises a planar segment flange 1220 that extends from a distal end thereof and curves towards an upper end 1215 of the device 1000. In the illustrated embodiment, the planar segment flange 1220 is substantially perpendicular to the planar segment 1210. In some embodiments, the planar segment 1210 services as a counterweight to balance the device 1000 over the gutter.

In the illustrated embodiment, the second end 1300 of the fastening member 1100 comprises a J-shaped channel 1310 disposed that is adapted to enclose an edge of the gutter. The J-shaped channel comprises a first side 1320 substantially parallel with a second side 1330, and a crossmember 1340 disposed therebetween. The crossmember 1340 of the channel 1310 is configured to mount atop an opposing second side of the gutter. In the illustrated embodiment, the planar segment 1210 terminates at a distal end of the first side 1320, wherein the crossmember 1340 is disposed above the planar segment 1210 and a distal end of the second side 1330 is disposed beneath the planar segment 1210 when the mounting device 1000 is secured to the gutter hanger. In the shown embodiment, the first end 1200 and the second end 1300 of the fastening member 1100 comprise a uniform width, wherein the width measured between lateral sides thereof.

In the illustrated embodiment, the fastening member 1100 is composed of a rigid material, such as metal. However, in alternate embodiments, the fastening member comprises any suitable material such as a hard plastic. In some embodiments, the fastening member is monolithic and formed from a single material. In other embodiments, the first end and the second end are formed using different materials from one another.

The mounting device 1000 further comprises an object fastener 1400 extending from an exterior side 1350 of the second side 1330 of the channel 1310. The object fastener 1400 is configured to receive and suspend an object therefrom. In the illustrated embodiment, the object fastener 1400 is C-shaped and comprises a base 1410 secured to the distal end of the second side 1330 of the fastening member 1100, a sidewall 1420 extending from the base 1410, and a top side 1430, wherein the top side opposes the base 1410 and extends perpendicularly from the sidewall 1420. In the illustrated embodiment, the base 1410 comprises a greater length than the top side, wherein a gap 1450 is formed between a distal end of the top side and the second side 1330. The gap 1450 is configured to receive the object therethrough so that it is received within the object fastener 1400.

In the illustrated embodiment, a fastening aperture 1500 is disposed within the base 1210 of the object fastener 1400. The fastening aperture 1500 is configured to receive a secondary clip or tie therethrough to further secure a wire of objected mounting within the object fastener 1400 to the device 1000.

In some embodiments, the mounting device 1000 comprises a counterweight disposed on the fastening member configured to allow heavier objects to be suspended from the object fastener. The counterweight is any suitable shape or material that provides additional weight to the fastening member 1100. In some embodiments, the counterweight comprises a weighted piece of plastic or metal disposed on an upper surface of the planar member 1210. In other embodiments, the counterweight comprises a weighted piece of plastic or metal that is suspended from the fastening member 1100, within the gutter, when the mounting device 1000 is secured thereto.

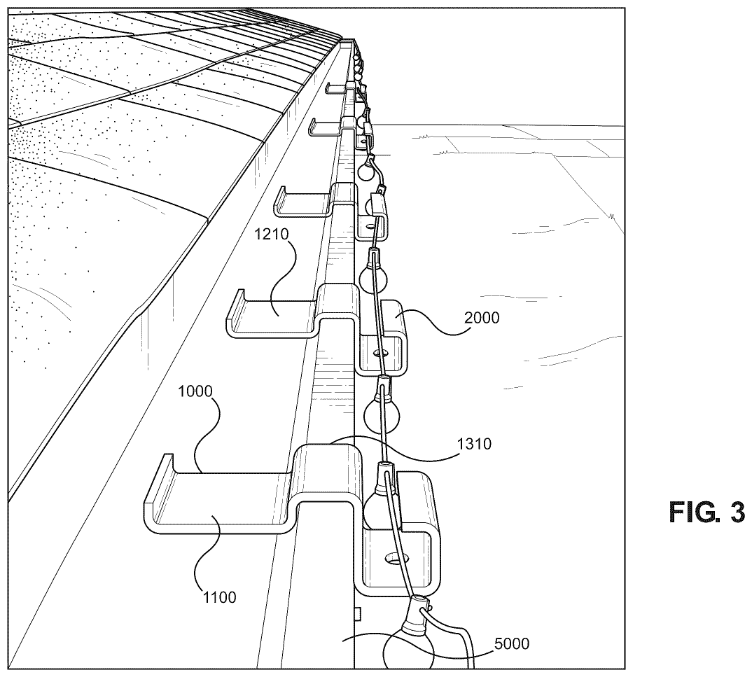

Referring now to FIGS. 3, there is shown perspective views of an embodiment of the mounting system in use. In the illustrated embodiment, the second side 1300 of the fastening member 1100 mounts over the edge of the second side of the gutter 5000, wherein the first end 1200 of the fastening member 1100 suspends over the gutter. When mounted, an interior side of the second side of the channel 1310 is configured to rest flush against an exterior of the second side of the gutter 5000. In some embodiments, the first end 1200 of the fastening member 1100 is configured to conceal or mimic the appearance of the gutter hanger. In the illustrated embodiment, the fastening member 1100 comprises a color that corresponds to a color of a portion of the gutter, to provide concealment thereof. In the illustrated embodiment, the width of the planar segment is equal to or greater than a width of a gutter hanger. The width of the planar segment is between 0.5 inches to 1.5 inches.

In the illustrated embodiment, a second mounting device 2000 is provided for suspending an object between a plurality of mounting devices. In operation, the second end of the fastening member 1100 is positioned over the edge of the gutter 5000 such that the object fastener 1400 overhangs the gutter 5000. An object, such as a string of lights, is threaded through each object fastener. In this way, the lights are hung on an exterior of a housing without permanently securing the mounting device to the gutter hanger, the gutter, or an exterior wall. Permanently meaning without the use of a fastener that punctures another structure in order to fasten to it, such as with a nail or screw.

In the shown embodiment, the object applies a downward force that causes the mounting device to bear against the gutter. The J-shaped channel prevents the rotation or other movement of the device, thereby securing the mounting device to the gutter. In some instances, a counterweight is used to prevent heavier objects from causing the disengagement of the mounting device from the gutter.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A mounting device for suspending an object, comprising:
a fastening member having a first end and an opposing second end, wherein the first end comprises a planar segment;
a fastening member having a planar segment disposed at a first end and a J-shaped channel disposed at a second end, wherein the first end is opposite the second end;
wherein the J-shaped channel formed by a series of bends that define the J-shaped channel, the channel comprising: a first side substantially parallel with a second side, wherein a crossmember is disposed between the first and second sides;
wherein the channel is adapted to enclose an edge of a gutter;
an object fastener extending from an exterior side of the second end of the fastening member, wherein the object fastener forms a substantially closed loop configuration with an opening and open lateral sides.

2. The mounting device of claim 1, wherein a distal end of the planar segment comprises a planar segment flange that is substantially perpendicular to the planar segment.

3. The mounting device of claim 1, wherein the object fastener is disposed on an exterior side of the second side of the J-shaped channel.

4. The mounting device of claim 1, wherein the planar segment terminates at a distal end of the first side of the J-shaped channel and the crossmember is disposed above the planar segment when the device is secured to the gutter.

5. The mounting device of claim 4, wherein a distal end of the second side is disposed beneath the planar segment when the device is secured to the gutter.

6. The mounting device of claim 1, wherein the first end and the second end comprise a uniform width, the width measured between lateral sides thereof.

7. The mounting device of claim 1, wherein the object fastener comprises a C-shaped hook having a base extending from the second side, a sidewall extending from the base and a top side extending from the sidewall, opposite the base.

8. The mounting device of claim 7, wherein the top side comprises a smaller length than the base forming a gap between the top side and the second side for receiving the object therethrough.

9. The mounting device of claim 1, further comprises a second mounting device for suspending an object between a plurality of mounting devices secured to the gutter.

10. The mounting device of claim 1, wherein an interior side of the second side is configured to rest flush against an exterior of the second side of the gutter.

11. The mounting device of claim 1, wherein the first end of the planar segment is configured to conceal a gutter hanger.

12. The mounting device of claim 1, further comprising a counterweight disposed on the first end of the fastening member.

13. The mounting device of claim 7, further comprising a fastening aperture disposed within the object fastener.

14. The mounting device of claim 13, wherein the fastening aperture is disposed on a base of the object fastener.

15. The mounting device of claim 14, wherein the base is parallel to the planar segment.

16. The mounting device of claim 1, wherein the mounting device is a monolithic structure.

17. The mounting device of claim 1, wherein the J-shaped channel is configured to receive a sidewall of a gutter and lock therewith.

18. The mounting device of claim 17, wherein the mounting device is joined with the gutter and an object is supported at a second end of the mounting device, the J-shaped channel remains engaged with the gutter and is configured to prevent disengagement due to an applied load of the object.
